(19) United States
(12) Patent Application Publication
(10) Pub. No.: US 2014/0372864 A1
(43) Pub. Date: Dec. 18, 2014

(54) OPPORTUNITY CARDS IN WEBSITES

(71) Applicant: Microsoft Corporation, Redmond, WA (US)

(72) Inventors: Richard Zaragoza, Issaquah, WA (US); Colleen Griffiths Estrada, Bellevue, WA (US); Jennifer Lauren Rodenhouse, Seattle, WA (US); James Lewallen, Fall City, WA (US); Todd D. Newman, Mercer Island, WA (US); Craig A. Jensen, Sammamish, WA (US); William L. Portnoy, Woodinville, WA (US)

(21) Appl. No.: 13/916,482

(22) Filed: Jun. 12, 2013

(51) Int. Cl. G06F 17/22

(52) U.S. Cl. CPC G06F 17/2247
USPC 715/234

(57) ABSTRACT

Aspects of the subject disclosure are directed towards opportunity cards that provide a user with straightforward access to other content of a website that may be interesting to a user, as well as other information and recommendations. Opportunity cards are generated for a user based upon user profile data, and may recommend and provide links to other website content that the user is likely to be interested in and/or has likely not already seen. The opportunity cards may be presented in conjunction with the content, such as inline, interspersed among a stream of posts of content.

### BACKGROUND

Websites often contain a significant amount of content. For example, websites corresponding to social networks are typically built around a vast feed of content that serves as the primary experience for most users. In interest networks (which include standard forum sites), the sites tend to be divided into interests or topical message boards. Such divisions encourage ‘siloed’ consumption and engagement with the content, and hinder discovery of additional content and/or people of interest.

Most users do not interact with much of the content that they might otherwise find interesting. For example, many websites are arranged as a single linear (e.g., in one or more columns) feed of posts, which does not help a user discover other facets of the network. Indeed, many people typically browse the first feed they see (often the “everyone” or “everything” feed). As a result, it is very possible that a user will never discover the rich content that the rest of the site has to offer.

Because users tend to stay in the first feed they find and not explore the rest of the site, they may also fail to find other areas of the site that otherwise would be interesting to them, or areas that would allow them to customize or enrich their experience in the primary feed. For example, forms in which users describe their areas of interests (or non-interest) may be located on a settings page that many users fail to find.

Some sites have separate static sections or headers that present the most globally popular sections on the site. A “hub” may be provided to guide site navigation. While useful, such solutions still suffer from requiring explicit, somewhat exploratory navigation by the user in order to engage with these other sections.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards outputting (e.g., presenting) opportunity cards to a user based upon the user's profile data, in which the opportunity cards provide a mechanism for the user to access other website content that is likely of interest to the user and/or receive information or an action to take regarding the website that is likely of interest to the user. One or more aspects are directed towards generating opportunity cards for a user based upon user-profile information, including searching for content and/or information related to a website. A set of opportunity cards may be generated based on a user's interests. The opportunity cards are filtered into a subset of opportunity cards that the user is likely to be interested in, and one or more of the opportunity cards are output from the subset for viewing by the user. Opportunity cards also may be created in the absence of (or in addition to) specific user information, based upon, for example, averaged or otherwise combined user interests, other users' behavior, trending topics, or popular users.

In one or more aspects, a website including a plurality of web servers is coupled to a data store that includes content and user profile data, in which the website includes an opportunity card generation and selection mechanism (e.g., algorithm). The opportunity card generation and selection mechanism is configured to request a search the content based upon the user profile data for a user and/or information about other (e.g., typical) users, and to generate opportunity cards for the user based upon results of the search. The mechanism selects opportunity cards to present to the user in conjunction with other rendered content.

One or more aspects are directed towards generating opportunity cards to present to a user from a website, in which the opportunity cards relate to other content in the website, and in which at least some of the opportunity cards provide links to the other content. One or more of the opportunity cards may be presented inline with a stream of content presented to the user, with an action taken based upon user interaction with an opportunity card.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for providing opportunity cards from website content based upon user profile data, according to one or more example implementations.

FIG. 2 is a representation of how an opportunity card may be interspersed within a stream of content (e.g., posts) presented to a user, according to one or more example implementations.

FIG. 3 is a representation of how an opportunity card may be presented on a page of content (e.g., posts) presented to a user, according to one or more example implementations.

FIG. 4 is a representation of opportunity cards and interactive elements thereon, according to one or more example implementations.

FIG. 5 is a flow diagram representing example steps that may be taken to generate and select opportunity cards, according to one or more example implementations.

FIG. 6 is a block diagram representing example non-limiting networked environments in which various embodiments described herein can be implemented.

FIG. 7 is a block diagram representing an example non-limiting computing system or operating environment in which one or more aspects of various embodiments described herein can be implemented.

### DETAILED DESCRIPTION

Various aspects of the technology described herein are generally directed towards generating and outputting opportunity cards (or simply “opportunities”), comprising one or more selected links and/or informational notifications related to a website. The opportunity cards may be generated based upon a user's profile, and may be output/presented in various ways, including interspersed inline among a stream of posts or otherwise associated with a stream of posts.

Opportunity cards may be generated for dynamically generated streams (e.g. related posts to a single post or searched by topic of interest) as well as existing, static streams. For example, a user may provide profile data that causes a stream to be dynamically generated when the user initially logs on, and/or a user may interact to select or search during a session, such as with respect to a topic of interest, and have a stream dynamically generated based upon the search results. Opportunity cards may be generated and/or selected for such streams.

More particularly, in one or more implementations, in addition to an “everyone” feed, the website system has the capability of dynamically generating feeds of posts. For example, given an interesting post in the everyone feed, a user can click that post to explore a series of related posts. Within that dynamically generated related post feed, the system may generate “opportunity cards” that enumerate some of the people, collections of interests, and/or activities that the system thinks the user will find the most interesting. These opportunity cards may be mixed in with the feed of posts, integrating naturally with the flow of browsing the site's content, and allowing the user to take action on these opportunities as part of their browsing and consuming experience. In addition, these opportunity cards provide links to explore the results of queries representing segments of the site's content that have been dynamically curated, rather than provided by users.

In general, opportunity cards may suggest and provide straightforward access to content or content sources (e.g., other users) to help users increase their engagement in a community, improve connections (e.g., expand social graphs), and discover additional content of interest (e.g., collections), without dedicated hubs, for example. Via opportunity cards, a user may see feeds of content generated dynamically for deeper exploration of a user's interest, and/or may be offered guidance based on past interactions with the site, new features of the site, and so on.

It should be understood that any of the examples herein are non-limiting. For example, opportunity cards may be presented with site content, however the technology described herein is not limited to such presentation. For example, an opportunity card may be emailed and/or output via a notification sent to a device, possibly not the same device that the user typically uses to access the site with which the opportunity card is associated. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, networking and providing content in general.

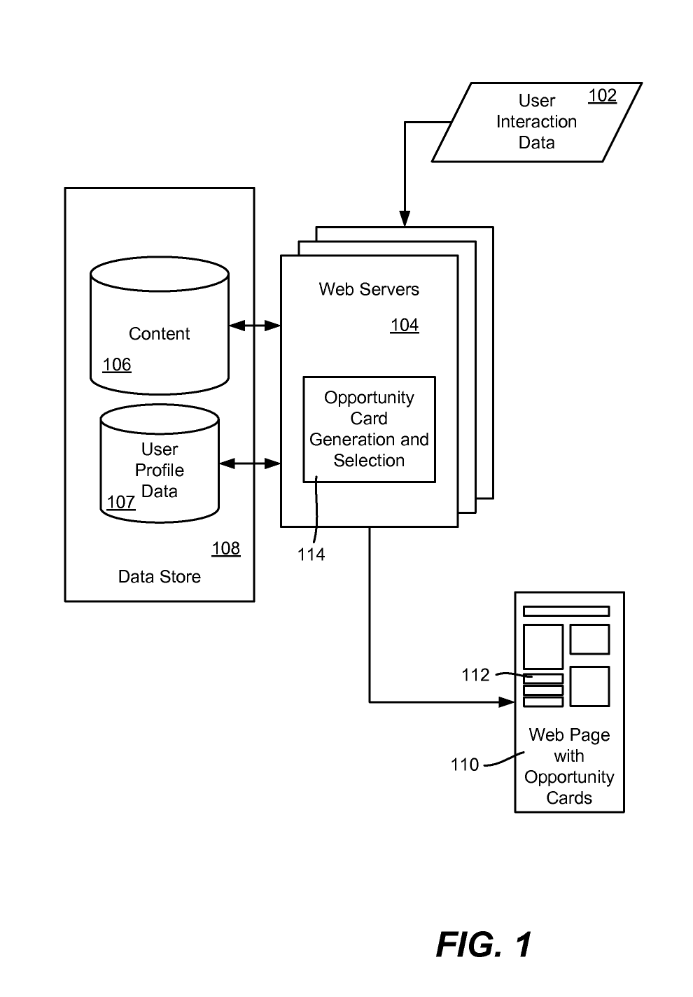

FIG. 1 is a block diagram showing example components by which opportunity cards may be generated and output in conjunction with other content. In general, a user interacts (block 102) with a set of web servers 104 to view content selected from the site's available content 106 in a data store 108. Users may log in, whereby content tailored to that user may be selected based upon user profile data 107. Note that the data store 108 shows the content 106 logically separated from the user profile data 107, however this is only for purposes of explanation, and the data store 108 may be organized in different ways.

As one example, a user who has registered an interest in classic cars may initially see posts related to classic cars. The user receives an interactive web page 110 containing the selected content. For example, the selected content may be arranged as a plurality of posts, arranged in time order, through which the user can scroll. In general, posts comprise images and accompanying text, possibly including comments, assembled and uploaded by various contributors to the website. For purposes of explanation herein, posts are used in the examples, however it is understood that opportunity cards are not limited to content in the form of posts.

As described herein, the interactive web page 110 includes one or more opportunity cards 112 that are generated for the user based upon the user profile data. Unlike conventional content, the opportunity cards are automatically generated and selected (block 114) for the user to provide information related to enhancing the user's experience with the site.

By way of example, an opportunity card may be generated to inform a user that a new collection (e.g., of posts) has been added to the site, providing the user with an opportunity to interact with the new collection. Such an opportunity card may be selected for the user based upon other topics in which the user is interested, e.g., “cats,” which may be determined by keyword matching other such techniques. Another opportunity card presented to a user may be based upon a person that the user follows, e.g., a friend, or a friend of a friend, (e.g., “Joe added a new collection” or “Jane added content to a collection”). Another opportunity card may be generated from keywords, current interests or activities of the user and so on, e.g., the user may be offered similar content to some content the user is currently following. An opportunity card need not be related to content or people, but instead may be informational, e.g., to inform the user of some new feature or change to the site that the user otherwise may not see.

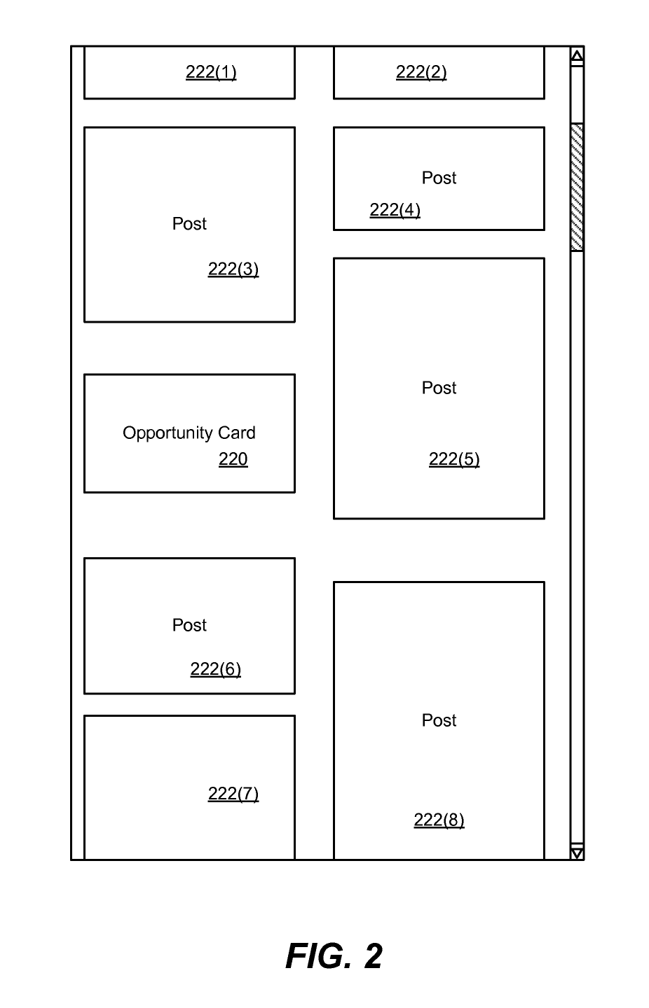

As generally represented in FIG. 2, in one implementation, opportunity card (e.g., opportunity card 220) may comprise items rendered (e.g., interspersed) in a stream of posts 222(1)-222(k) (of which posts or partial posts 222(1)-222(8) are shown). The interspersing may be random, pseudo-random, at a regular interval, based upon page layout, and so on; in one implementation opportunity cards are distributed regularly or somewhat regularly around every ten-to-twenty posts.

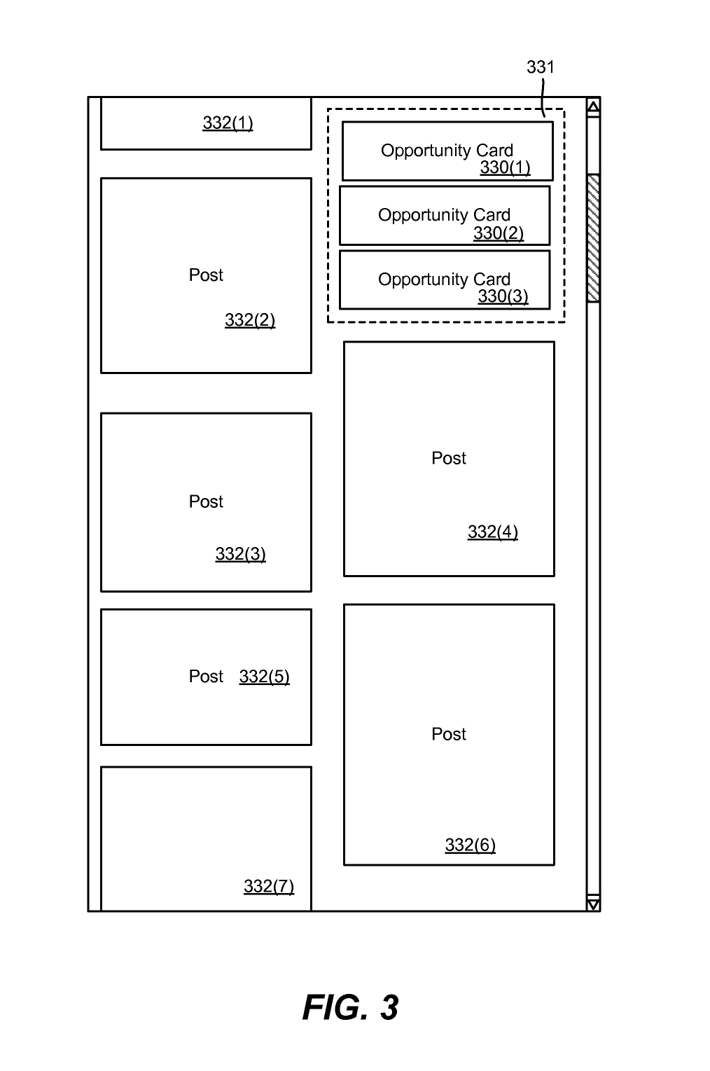

The opportunity cards may generally look like other posts, or may be intentionally designed to be visually different in some way from other posts to easily differentiate (e.g., call attention to) them. An opportunity card may be rendered at the top of each “virtual” page of results in a “posts” view that shows the posts. Instead of (or in addition to) inline opportunity cards, as represented in FIG. 3, one or more opportunity cards 330(1)-330(3) may be in a different region 331 reserved for them, e.g., to the upper right of a screen, and may not scroll with the page as posts 332(1)-332(k) are scrolled through

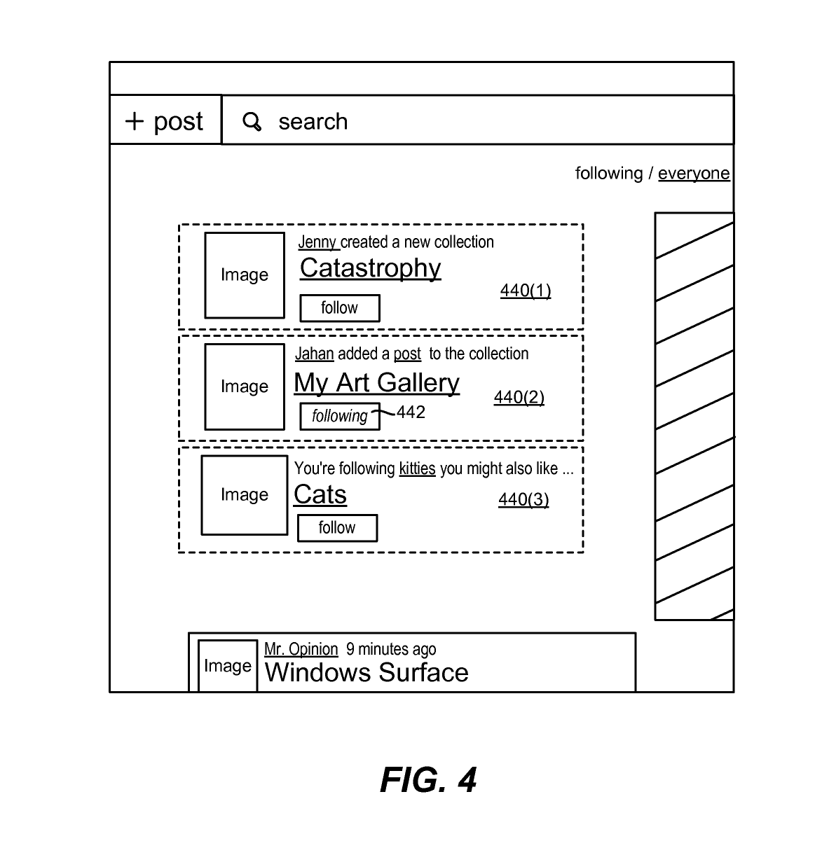

As represented in FIG. 4, an opportunity card may include multiple types of opportunity actions within a single opportunity card “post.” For example, the opportunity cards 440(1)-440(3) in FIG. 4 each have opportunity actions that the user can take, such as in the form of clickable links that may be clicked, and possibly hovered over. Such actions are represented in FIG. 4 by underlining of text within the opportunity cards 440(1)-440(3), however it is understood that instead of underlining, different colors, boldness, font sizes and so on may be used to indicate to the user that an opportunity may be selected. An image, if present in an opportunity card, also may be clickable.

By way of example, “Jahan” in the text of the opportunity card 440(1) may be a hoverable and clickable link. Clicking this opportunity takes the user to content (e.g., posts) associated with the user named Jahan. The user may also click “post” to see the particular newly added post. The link “My Art Gallery” is clickable and navigates to a corresponding collection named as such.

A user thus may elect to jump to the new content via an opportunity action in an opportunity card. Alternatively, another action that the user may take is to select “Follow” within the opportunity card, whereby the user stays at the current set of content (e.g., the current location in the stream) but has the posts (e.g., the collection) identified in the opportunity card added to the current stream for the user to scroll to when desired. Note that in the opportunity card 440(2) the button 442 has changed from “Follow” to “Following” to indicate that the user already elected to follow that opportunity; although the button text in FIG. 4 is shown as italics, it is understood that alternative ways to help the user notice the state change, such as a grayed out appearance of the button, may be used. A user may toggle the button back to “Follow” and remove the associated posts from the stream in one or more implementations.

To give users opportunity cards that are likely relevant to the user while avoiding repetition, opportunity card options in one implementation are chosen based on weighted random chance. There are different types of opportunities, and each type of opportunity may have a weight corresponding to a specific configurable percentage chance that the type will be chosen. This chance can be overridden or reweighted by detected user behavior; (e.g., a user who has been interested in “hot dog” posts today may be given an opportunity card asking the user whether he or she “would like to follow the hot dog collection”).

Opportunities can also be chosen based on implied data from the user's recent behavior (the one being shown an opportunity). By way of example, if a user buys a barbecue and starts interacting with related content (as the user has just started that interest), the system may create and highly prioritize an opportunity or set of opportunities that directed the user to barbecue related posts, users, and collections. In other words, this is “inferred” data about the user profile based on behavior rather than “explicit” data. Moreover, the behavior may be obtained from another source, e.g., a shopping website may provide information about a recent user purchase, which may then be used in generating an opportunity card.

Thus, there are different types of opportunities, and each may be weighted differently. The following table exemplifies some possible types and rules and weights related thereto; it is understood that the table entries are only examples, and that not all exemplified types may be present in a given implementation, and/or that other types may be added:

| | Impl. | | |
|---|---|---|---|
| Speclet | Order | Scope | Weighting |
| “Social NW Friends” | 1 | EVERYONE/ | .1 |
| Find your Social NW Friends: | | FEATURED | |
| Invoke the Social NW friend | | | |
| finder (which may be rare) | | | |
| “RecommendedCollection” | 2 | FOLLOWING/ | .2 |
| Recommended Collections: | | EVERYONE | |
| USER's FRIENDS that have | | | |
| created a new COLLECTION in | | | |
| the last 7 days that user is NOT | | | |
| already following | | | |
| Collection needs > 3 posts | | | |
| “PostedToCollection” | 3 | FOLLOWING | .2 |
| Collection Activity on a | | | |
| Collection user Follows: | | | |
| Someone has made a | | | |
| contribution in the last 24 hrs to | | | |
| a collection user follows | | | |
| “PostAddedToCollection” | 4 | EVERYONE/ | .4 |
| Collection to follow based on | | FOLLOWING | |
| post activity: | | | |
| Top 100 popular Collections (by | | | |
| Follower Count) filtered by items | | | |
| with a low ActivityRank | | | |
| Any activity in that collection | | | |
| over the last 24 hours | | | |
| Minimum of 3 posts need to | | | |
| be added in time period | | | |
| “PopularPerson” | 5 | EVERYONE/ | .4 |
| People with lots of (e.g., recent) | | FEATURED | |
| followers who have been | | | |
| recently active | | | |
| Minimum of 5 followers in | | | |
| last week | | | |
| “RecommendedPerson” | 6 | FOLLOWING | .1 |
| People to Follow | | | |
| Recommendations based on | | | |
| overlapping Interests + | | | |
| Following: | | | |
| FRIENDS of USER'S FRIENDS | | | |
| where user and the FRIEND of | | | |
| FRIEND have PUBLIC | | | |
| COLLECTIONS in common and | | | |
| user is NOT already | | | |
| FOLLOWING the friend of a | | | |
| friend | | | |
| Recommended Collection that | 7 | FOLLOWING | .3 |
| user does not already follow | | | |
| based on Interests & Profile | | | |
| Recommended Collection that | 8 | FOLLOWING | .3 |
| user does not already follow | | | |
| based on similarity to another | | | |
| collection | | | |
| Collection based on user's own | 9 | FOLLOWING | .3 |
| activity (e.g., user liked 10 hot | | | |
| dog posts, how about a hot dog | | | |
| interest collection) | | | |

As can be seen from the example table, some of the types have rules that need to be met before an opportunity card will be generated. For example, some of the rules include that any new recommended collections need to be actually new (within the last seven days) and not already followed by the user. A “collection” needs to have at least three posts to be considered a collection. Contributions to an existing, followed collection need to be recent, e.g., made within the last 24 hours of the session; e.g., a collection recommended because of popularity also needs to be current, e.g., there may be many formerly popular collections regarding the 2012 London Olympic games, but the popularity has waned over time and thus such a collection is not current. Other example rules may be seen in the table. It is understood that the values (e.g., timeframes, number of posts, and so on) that a rule evaluates are only examples, and that these values may be tweaked and/or learned for a given implementation.

Each of the types has a weight that will be a factor in how frequently that type of opportunity appears. The weights generally attempt to bias the types to those a user is likely more interested in seeing, while giving likely less interesting ones some visibility. In one or more implementations, the user may configure some of the weights per-user preferences, e.g., those that are not globally weighted, with per-user weights maintained as part of the user profile data, for example. It is understood that the above table entries including the weights therein are only examples, and that different values and the like may be used, e.g., learned through user feedback, such as how often each type of opportunity card is clicked.

Scoring of collections of interests may be done by an activity rank measure. Opportunity card recommendations can be made based on secondary shared attributes, such as tags on collections of interests as well as intersections of user behaviors/likes/shared interests/follows. Opportunity card recommendations also may be based on things the user has not done yet, such as adding personal information, selecting general areas of interest, and/or providing contact information for other social sites.

With respect to each opportunity card type, a selection process attempts to prepare a variety of results that avoids repetition of the same opportunities (suggestions) over and over again to the user within a given session. A session may be time-based, based upon login and logout, or some other criteria (e.g., three logins and logouts). To avoid repetition, the selection process may choose randomly within the set of values for a given opportunity.

Note that each time a person adds a post to a collection, a different opportunity card may be generated, e.g., “Jahan added a post to the collection” (as in FIG. 4). However, if the person adds posts multiple times, such as within a short timeframe, this may be somewhat redundant, in that each such opportunity card refers to the same thing, e.g., a notification of a new post that a user can see all at once. Such otherwise separate opportunity cards may be merged or “deduplicated” so that the user only receives one opportunity card for the plurality of posts in the timeframe. Alternatively, if the user accesses the collection via any one of the related opportunity cards, any others generated before the access time are no longer needed and may be removed from the subset available to the user so that the user never sees them.

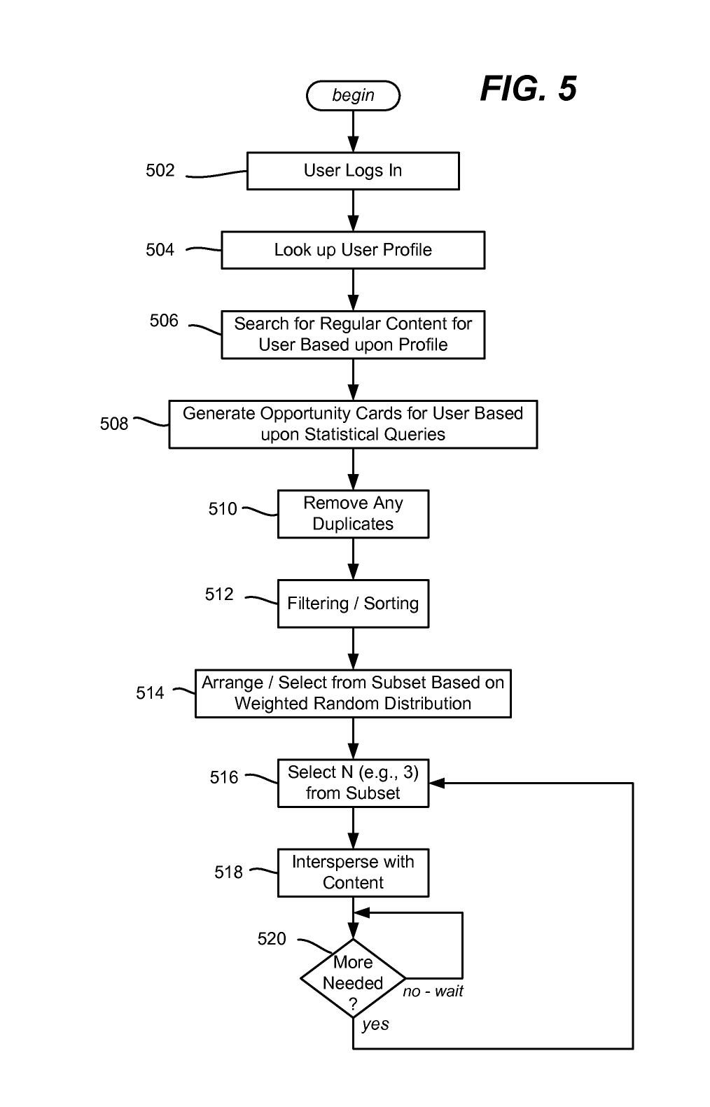

FIG. 5 summarizes some of the above concepts via example steps of a flow diagram. To generate opportunity cards for a user who logs in (step 502), one or more implementations use the user profile data (step 504) and current site information to obtain content for the user (step 506) and make statistics-based queries over the content store for generating opportunity cards (step 508). For example, searching may result in three hundred to five hundred potential opportunity cards. Examples of such search criteria may include what and who the user has previously followed, what and who the user is currently following or viewing, interests of the user, friends of the user, friends of friends, what is popular in the site, what happened recently, and possibly external data (e.g., what is in the news), and so on. Note that opportunity cards are per user, and thus are generally not cached for sharing among other users, however certain ones (e.g., corresponding to global popularity) may be shared among different users and thus cached rather than dynamically generated on demand. Further, users may be clustered in to groups by profile data, and at least some opportunity cards may be shared among the cluster, for example, rather than dynamically generated for each user.

Different algorithms may be used to search for the opportunities/cards, such as for different search criteria and different types of opportunities. As a result, there may be duplicates. Duplicate detection, e.g., via a hash of the content or part thereof may be used to eliminate duplicates (step 510). A dictionary of {hash value, corresponding opportunity card content} entries or the like may be maintained and access for this purpose.

From this set of opportunities/cards, as represented via steps 512 and 514, the process may filter the set (e.g., to determine which fifty or so are the most appropriate for the user) into a subset that may be ranked and/or ordered. This may be based upon various filtering criteria, such as to recommend a new collection from someone the user knows, recommend a collection in an area of interest of the user, recommend a new user to the system who the use knows otherwise (e.g., a friend on another social network), follow a person who has common interests with the user, follow a person whom a friend (or someone the user follows) has just decided to follow, and so on.

From this reduced subset, at step 516 some number N (e.g., 3) of opportunity cards may be selected and mixed into or otherwise associated with the content for the user, e.g., interspersed into the stream of posts a user is about to have rendered for viewing (step 518). The subset is maintained so that more opportunity cards are available as needed during the session, e.g., as represented by step 520.

Note that opportunity cards need not be generated during a session as in FIG. 5, but may be generated independent of a session. Indeed, an opportunity may be generated at any time and proactively sent as a notification to any user device, e.g., emailed to a user, sent by text or SMS message to a mobile device, and so on.

As can be seen, opportunity cards provide a straightforward natural way to increase connections among members and help users discover topics of interest. Other benefits of opportunity cards include a way to notify a user of a missed activity, and to encourage activities that may increase the value of the site for the user.

### Example Networked and Distributed Environments

One of ordinary skill in the art can appreciate that the various embodiments and methods described herein can be implemented in connection with any computer machine or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

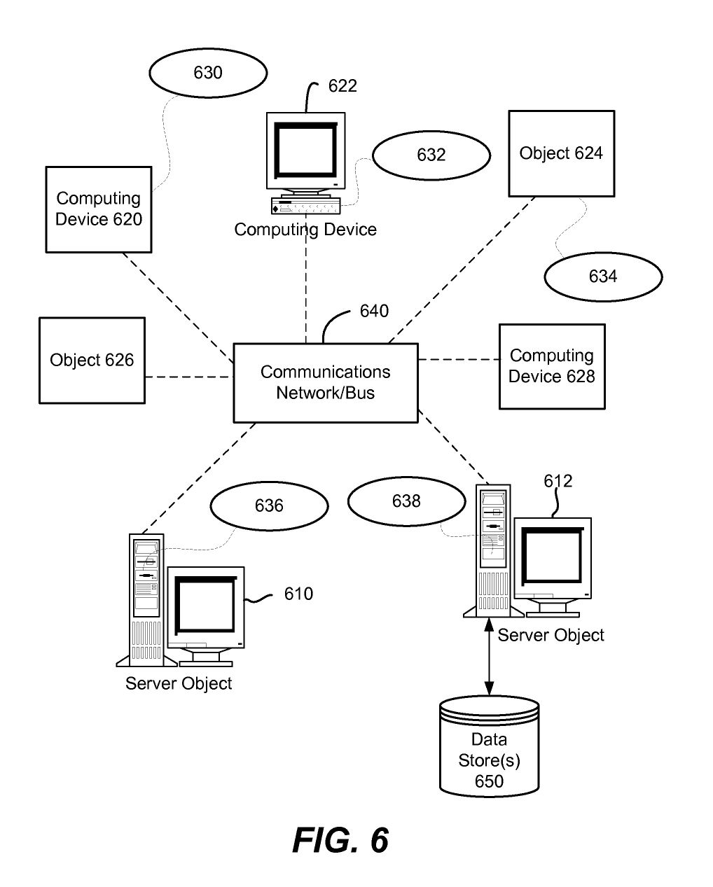

FIG. 6 provides a schematic diagram of an example networked or distributed computing environment. The distributed computing environment comprises computing objects 610, 612, etc., and computing objects or devices 620, 622, 624, 626, 628, etc., which may include programs, methods, data stores, programmable logic, etc. as represented by example applications 630, 632, 634, 636, 638. It can be appreciated that computing objects 610, 612, etc. and computing objects or devices 620, 622, 624, 626, 628, etc. may comprise different devices, such as personal digital assistants (PDAs), audio/video devices, mobile phones, MP3 players, personal computers, laptops, etc.

Each computing object 610, 612, etc. and computing objects or devices 620, 622, 624, 626, 628, etc. can communicate with one or more other computing objects 610, 612, etc. and computing objects or devices 620, 622, 624, 626, 628, etc. by way of the communications network 640, either directly or indirectly. Even though illustrated as a single element in FIG. 6, communications network 640 may comprise other computing objects and computing devices that provide services to the system of FIG. 6, and/or may represent multiple interconnected networks, which are not shown. Each computing object 610, 612, etc. or computing object or device 620, 622, 624, 626, 628, etc. can also contain an application, such as applications 630, 632, 634, 636, 638, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 6, as a non-limiting example, computing objects or devices 620, 622, 624, 626, 628, etc. can be thought of as clients and computing objects 610, 612, etc. can be thought of as servers where computing objects 610, 612, etc., acting as servers provide data services, such as receiving data from client computing objects or devices 620, 622, 624, 626, 628, etc., storing of data, processing of data, transmitting data to client computing objects or devices 620, 622, 624, 626, 628, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 640 or bus is the Internet, for example, the computing objects 610, 612, etc. can be Web servers with which other computing objects or devices 620, 622, 624, 626, 628, etc. communicate via any of a number of known protocols, such as the hypertext transfer protocol (HTTP). Computing objects 610, 612, etc. acting as servers may also serve as clients, e.g., computing objects or devices 620, 622, 624, 626, 628, etc., as may be characteristic of a distributed computing environment.

### Example Computing Device

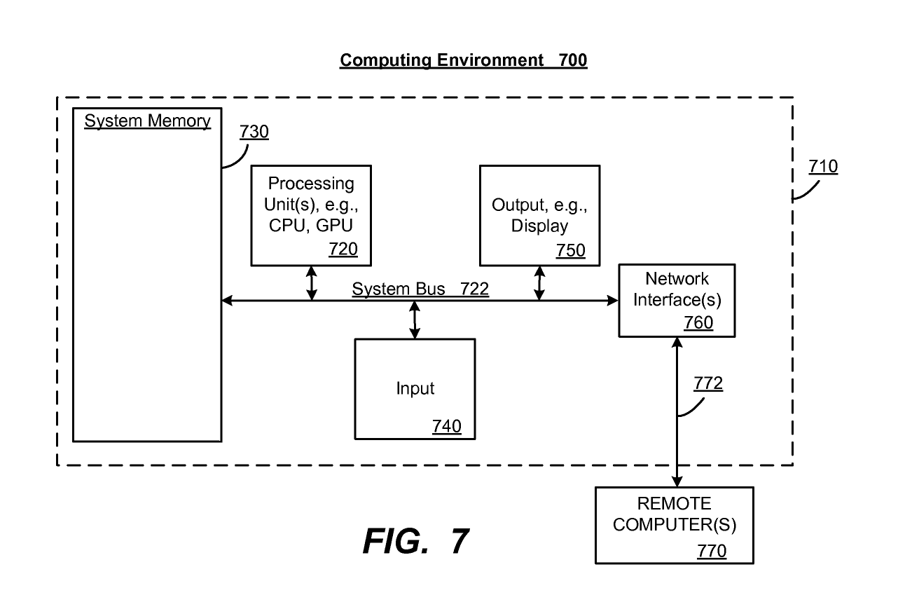

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 7 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 7 thus illustrates an example of a suitable computing system environment 700 in which one or aspects of the embodiments described herein can be implemented, although as made clear above, the computing system environment 700 is only one example of a suitable computing environment and is not intended to suggest any limitation as to scope of use or functionality. In addition, the computing system environment 700 is not intended to be interpreted as having any dependency relating to any one or combination of components illustrated in the example computing system environment 700.

With reference to FIG. 7, an example remote device for implementing one or more embodiments includes a general purpose computing device in the form of a computer 710. Components of computer 710 may include, but are not limited to, a processing unit 720, a system memory 730, and a system bus 722 that couples various system components including the system memory to the processing unit 720.

Computer 710 typically includes a variety of computer readable media and can be any available media that can be accessed by computer 710. The system memory 730 may include computer storage media in the form of volatile and/or nonvolatile memory such as read only memory (ROM) and/or random access memory (RAM). By way of example, and not limitation, system memory 730 may also include an operating system, application programs, other program modules, and program data.

A user can enter commands and information into the computer 710 through input devices 740. A monitor or other type of display device is also connected to the system bus 722 via an interface, such as output interface 750. In addition to a monitor, computers can also include other peripheral output devices such as speakers and a printer, which may be connected through output interface 750.

The computer 710 may operate in a networked or distributed environment using logical connections to one or more other remote computers, such as remote computer 770. The remote computer 770 may be a personal computer, a server, a router, a network PC, a peer device or other common network node, or any other remote media consumption or transmission device, and may include any or all of the elements described above relative to the computer 710. The logical connections depicted in FIG. 7 include a network 772, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A machine-implemented method comprising, generating opportunity cards for a user, including searching for content or information, or both, related to a website, filtering the opportunity cards into a subset of opportunity cards that the user is likely to be interested in, and outputting one or more of the opportunity cards from the subset for viewing by the user.

2. The method of claim 1 wherein generating the opportunity cards for the user comprises accessing user profile information and basing at least some of the opportunity cards on the user profile information.

3. The method of claim 1 wherein generating the opportunity cards for the user comprises basing at least some of the opportunity cards on at least one of: other user interests, other user behavior, a trending topic, or one or more popular users.

4. The method of claim 1 wherein outputting the one or more of the opportunity cards comprises mixing the one or more opportunity cards with content displayed during interaction with the website.

5. The method of claim 4 wherein the content comprises a linear feed of posts, and wherein mixing the one or more opportunity cards with the content comprises interspersing at least one opportunity card into the linear feed of posts.

6. The method of claim 1 further comprising, selecting opportunity cards from the subset based upon weighted random distribution.

7. The method of claim 1 further comprising, selecting at least one opportunity card from the subset based upon the user's current or recent activity or behavior.

8. The method of claim 1 wherein generating the opportunity cards comprises providing at least one interactive element within an opportunity card.

9. The method of claim 1 wherein generating the opportunity cards comprises providing a plurality of interactive elements corresponding to action options within at least some of the opportunity cards.

10. The method of claim 9 wherein providing the plurality of interactive elements corresponding to action options comprises providing an interactive button on an opportunity card, which if selected, adds content associated with the opportunity card to a stream of content being viewed by the user.

11. The method of claim 1 further comprising, dynamically generating a stream of content for interactive viewing by the user, and wherein generating the opportunity cards is based upon the stream of content.

12. The method of claim 1 wherein generating the opportunity cards comprises generating an opportunity card that provides an interactive element corresponding to a user, or generating an opportunity card that provides an interactive element corresponding to a collection, or both generating an opportunity card that provides an interactive element corresponding to a user and an interactive element corresponding to a collection.

13. The method of claim 1 wherein filtering the opportunity cards into the subset comprises determining whether to include an opportunity card based upon time data associated with a collection of content, or based upon a number of additions to a collection of content, or based upon both time data associated with a collection of content and based upon a number of additions to the collection of content.

14. A system comprising, a website including a plurality of web servers coupled to a data store that includes content and user profile data, the website including an opportunity card generation and selection mechanism configured to request a search of the content based upon the user profile data for a user and generate opportunity cards for the user based upon results of the search, and select opportunity cards to present to the user in conjunction with other rendered content.

15. The system of claim 14 wherein the opportunity card generation and selection mechanism selects an opportunity card based upon a collection of content that has been created within a certain timeframe, and the collection is one that the user is not already following.

16. The system of claim 14 wherein the opportunity card generation and selection mechanism selects an opportunity card based upon activity in a collection of content that the user follows, in which the activity occurred within a certain timeframe.

17. The system of claim 14 wherein the opportunity card generation and selection mechanism selects an opportunity card based upon popularity of a collection of content or popularity of a contributor to a collection of content.

18. The system of claim 14 wherein the opportunity card generation and selection mechanism selects an opportunity card based upon a friend relationship with another person.

19. The system of claim 14 wherein the opportunity card generation and selection mechanism selects an opportunity card to provide information corresponding to a website feature or to recommend an action to a user to take to provide input.

20. One or more computer-readable storage media or logic having computer-executable instructions, which when executed perform steps, comprising, generating opportunity cards to present to a user interacting with a website, in which the opportunity cards relate to other content in the website, and in which at least some of the opportunity cards provide links to the other content, presenting one or more of the opportunity cards inline with a stream of content presented to the user, and taking an action based upon user interaction with an opportunity card.
